(19) United States
(12) Patent Application Publication
(10) Pub. No.: US 2020/0200341 A1
(43) Pub. Date: Jun. 25, 2020

(54) Detachable Night Lamp

(71) Applicant: Dongguang Keetat Lighting Ltd., Dongguan (CN)

(72) Inventors: Ka Yiu On, Dongguan (CN); Chuan Yang, Dongguan (CN); Lin Tan, Dongguan (CN); Hongguo Ling, Dongguan (CN); Liang Yin, Dongguan (CN); Nanxi Peng, Dongguan (CN)

(73) Assignee: Dongguang Keetat Lighting Ltd.

(21) Appl. No.: 16/256,037

(22) Filed: Jan. 24, 2019

(30) Foreign Application Priority Data
Dec. 19, 2018 (CN) 201822143531.2

(51) Int. Cl. F21S 8/00; F21V 23/04; H01H 9/18; F21V 17/18; H05B 37/02; H01R 13/66; H01R 13/70

(52) U.S. Cl. CPC F21S 8/035; F21V 23/04; H01H 9/18; F21V 17/18; H01R 24/76; H01R 13/665; H01R 13/70; H01H 2219/036; H05B 37/02

(57) ABSTRACT

The present invention relates to night lamps and particularly to a detachable night lamp. The detachable night lamp includes a lampshade, a mounting base, a circuit board installed in the mounting base and having an illuminator electrically connected to the circuit board, a receiving chamber formed at the top surface of the mounting base. The receiving chamber has a through hole corresponding to the illuminator. A plug connector is installed at the bottom end of the lampshade for connecting the receiving chamber and the plug connector includes a cylinder connected to the bottom of the lampshade bottom, and a semi-circular fastening ring disposed on the outer wall of the cylinder. A fastening block is disposed on an inner wall of the receiving chamber for connecting the semi-circular fastening ring. The mounting base and the lampshade have a detachable design.

### FIELD OF THE INVENTION

The present invention generally relates to the field of night lamps, and more particularly to a detachable night lamp.

### BACKGROUND OF THE INVENTION

For the convenience of nighttime activities, night lamps are used extensively in our daily life. In addition to the basic lighting function, the night lamps may be used for interior decoration to cheer up the atmosphere. However, most conventional night lamps come with an integral design including a lamp holder and a night lamp body, and the integral design means that when it is necessary to change a night lamp with a different shape, we must buy a number of night lamps. Obviously, it is necessary to design a night lamp that can change the shape of the lampshade at will.

In view of the aforementioned drawbacks of the prior art, the inventor of the present invention based on years of experience in the related industry to conduct extensive research and experiment, and finally provided a feasible solution to overcome the drawbacks of the prior art.

### SUMMARY OF THE INVENTION

Therefore, it is a primary objective of the present invention to overcome the aforementioned drawbacks of the prior art by providing a detachable night lamp capable of changing the lampshade with a different shape conveniently.

To achieve the aforementioned and other objectives, the present invention provides a detachable night lamp comprising: a lampshade, a mounting base, a circuit board disposed in the mounting base; an illuminator installed onto the circuit board and electrically coupled to the circuit board, and a receiving chamber formed at the top surface of the mounting base and having a through hole formed at a position corresponding to the illuminator; the lampshade having a plug connector disposed at the bottom end thereof and provided for latching and coupling the receiving chamber; the plug connector including a cylinder coupled to the bottom of the lampshade and a semi-circular fastening ring disposed on an outer wall of the cylinder; and the receiving chamber having a fastening block disposed on an inner wall thereof and provided for latching and coupling the semi-circular fastening ring.

In the detachable night lamp of the present invention, the fastening block includes a horizontal portion and a vertical portion coupled to each other to form an inverted L-shape.

In the detachable night lamp of the present invention, the semi-circular fastening ring has a notch formed thereon, and the horizontal portion has a bump provided for latching and coupling with the notch.

In the detachable night lamp of the present invention, the horizontal portion has a guided oblique block disposed at an end of the horizontal portion which is away from the vertical portion.

In the detachable night lamp of the present invention, the semi-circular fastening ring has a chamfer disposed at a bottom edge thereof

In the detachable night lamp of the present invention, the mounting base includes a first base and a second base, and the first base and the second base are detachably coupled, and the first base has a latch bump, and the second base has a latch groove for latching and coupling the latch bump.

In the detachable night lamp of the present invention, the latch bump is disposed on an inner wall of the first base, and the latch groove is formed on an inner wall of the second base, and the latch groove has a chamfer disposed at the top thereof

The detachable night lamp of the present invention further comprises a diffusion hood mounted onto the through hole.

The detachable night lamp of the present invention further comprises an induction lamp bead, and the mounting base having a via hole formed on a sidewall thereof, and the induction lamp bead being installed in the via hole, and both of the induction lamp bead and the illuminator being electrically coupled to the circuit board.

In the detachable night lamp of the present invention, the circuit board further comprises a mains electricity interface AC1, a mains electricity interface AC2, a rectifier module, a control module and a control switch module; the control switch module comprises a disconnect switch SW1, a full-brightness switch SW2, an automatic-brightness switch SW3 and a half-brightness switch SW4; both of the mains electricity interface AC1 and the mains electricity interface AC2 are coupled to the control module through the rectifier module; the control module comprises a positive input node N5 coupled to a positive output terminal of the rectifier module and a negative input node N6 coupled to a negative output terminal of the rectifier module; the control module further comprises a field effect transistor Q1, a field effect transistor Q2, a field effect transistor Q3, a photosensitive triode transistor Q4, a pull-up resistor R2, a pull-up resistor R3, a pull-up resistor R4 and a pull-up resistor R5; a pull-up resistor R2 and an illuminator are coupled to each other and installed sequentially between the positive input node N5 and the negative input node N6; the disconnect switch SW1 has an end coupled to the positive input node N5 through the pull-up resistor R3; the half-brightness switch SW4 has an end coupled to the positive input node N5 through the pull-up resistor R4; the full-brightness switch SW2 has an end coupled to the positive input node N5 through the pull-up resistor R4 and the other end suspended in the air; a node N1 and a node N2 are disposed between the pull-up resistor R2 and the illuminator; and the other end of the disconnect switch SW1 is coupled to a gate of the field effect transistor Q1; a drain of the field effect transistor Q1 is coupled to the node N1; a source of the field effect transistor Q1 is coupled to the negative input node N6; the automatic-brightness switch SW3 has an end coupled to a collector of the photosensitive triode transistor Q4 and the other end coupled to a gate of the field effect transistor Q1; an emitter of the photosensitive triode transistor Q4 is coupled to the positive input node N5; a node N3 is disposed between the other end of the automatic-brightness switch SW3 and the gate of the field effect transistor Q1; the other end of the half-brightness switch SW4 is coupled to a gate of the field effect transistor Q2; a source of the field effect transistor Q2 is coupled to the negative input node N6; a drain of the field effect transistor Q2 is coupled to the node N2; a node N4 is disposed between the other end of the half-brightness switch SW4 and the gate of the field effect transistor Q2; a gate of the field effect transistor Q3 is coupled to the node N4; a drain of the field effect transistor Q3 is coupled to a collector of the photosensitive triode transistor Q4; a source of the field effect transistor Q3 is coupled to the gate of the field effect transistor Q1 through the node N3; the source of the field effect transistor Q3 is coupled to the negative input node N6 through the node N3 and the pull-up resistor R5 sequentially; a resistor R6 is installed between the drain of the field effect transistor Q2 and the node N2; and the node N4 is coupled to a negative input node N6 through a resistor R7.

In summation, the present invention has the following advantages and effects: With the detachable design of the mounting base and lampshade, the plug connector and receiving chamber are provided for changing or assembling the lampshade conveniently to achieve high practicality and save resources. With the induction lamp bead capable of sensing the intensity of ambient light, the brightness of the night lamp can be adjusted automatically.

### BRIEF DESCRIPTION OF THE DRAWINGS

FIG. 1 is an exploded view of a detachable night lamp in accordance with the present invention;

FIG. 2 is another exploded view of a detachable night lamp in accordance with the present invention;

FIG. 3 is a schematic view showing a first appearance of a lampshade in accordance with the present invention;

FIG. 4 is a schematic view of the whole structure of a mounting base in accordance with the present invention;

FIG. 5 is an exploded view of a mounting base in accordance with the present invention;

FIG. 6 is a partial blowup view of Section A of FIG. 3;

FIG. 7 is a partial blowup view of Section B of FIG.5;

FIG. 8 is a schematic circuit diagram of the present invention;

FIG. 9 is a schematic view showing a second appearance of a lampshade in accordance with the present invention;

FIG. 10 is a schematic view showing a third appearance of a lampshade in accordance with the present invention;

FIG. 11 is a schematic view showing a fourth appearance of a lampshade in accordance with the present invention;

FIG. 12 is a schematic view showing a fifth appearance of a lampshade in accordance with the present invention;

FIG. 13 is a schematic view showing a sixth appearance of a lampshade in accordance with the present invention;

FIG. 14 is a schematic view showing a seventh appearance of a lampshade in accordance with the present invention;

FIG. 15 is a schematic view showing an eighth appearance of a lampshade in accordance with the present invention;

FIG. 16 is a schematic view showing a ninth appearance of a lampshade in accordance with the present invention;

FIG. 17 is a schematic view showing a tenth appearance of a lampshade in accordance with the present invention;

FIG. 18 is a schematic view showing an eleventh appearance of a lampshade in accordance with the present invention;

FIG. 19 is a schematic view showing a twelfth appearance of a lampshade in accordance with the present invention;

FIG. 20 is a schematic view showing a thirteenth appearance of a lampshade in accordance with the present invention;

FIG. 21 is a schematic view showing a fourteenth appearance of a lampshade in accordance with the present invention;

FIG. 22 is a schematic view showing a fifteenth appearance of a lampshade in accordance with the present invention;

FIG. 23 is a schematic view showing a sixteenth appearance of a lampshade in accordance with the present invention;

FIG. 24 is a schematic view showing a seventeenth appearance of a lampshade in accordance with the present invention;

FIG. 25 is a schematic view showing an eighteenth appearance of a lampshade in accordance with the present invention;

FIG. 26 is a schematic view showing a nineteenth appearance of a lampshade in accordance with the present invention;

FIG. 27 is a schematic view showing a twentieth appearance of a lampshade in accordance with the present invention;

FIG. 28 is a schematic view showing a twenty-first appearance of a lampshade in accordance with the present invention;

FIG. 29 is a schematic view showing a twenty-second appearance of a lampshade in accordance with the present invention;

FIG. 30 is a schematic view showing a twenty-third appearance of a lampshade in accordance with the present invention;

FIG. 31 is a schematic view showing a twenty-fourth appearance of a lampshade in accordance with the present invention;

FIG. 32 is a schematic view showing a twenty-fifth appearance of a lampshade in accordance with the present invention; and

FIG. 33 is a schematic view showing the internal structure of a lampshade with the twenty-fifth appearance in accordance with the present invention.

### DESCRIPTION OF THE PREFERRED EMBODIMENTS

The technical contents of the present invention will become apparent with the detailed description of preferred embodiments accompanied with the illustration of related drawings as follows. It is intended that the embodiments and figures disclosed herein are to be considered illustrative rather than restrictive.

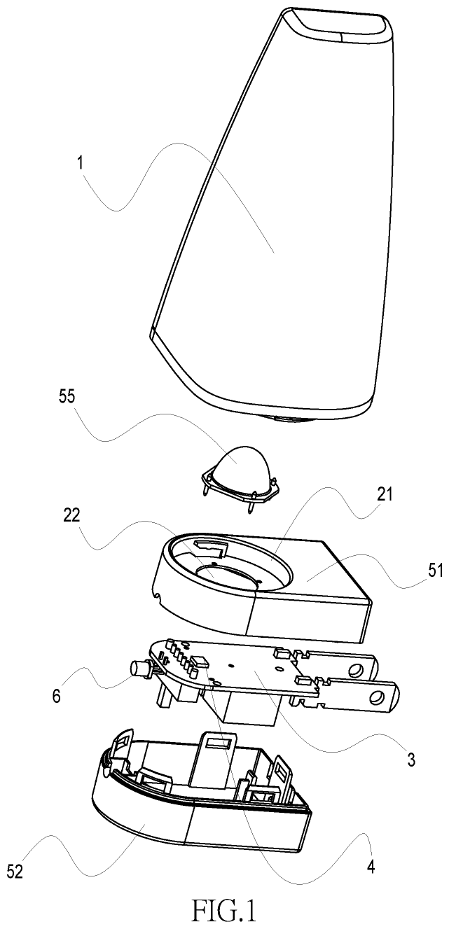

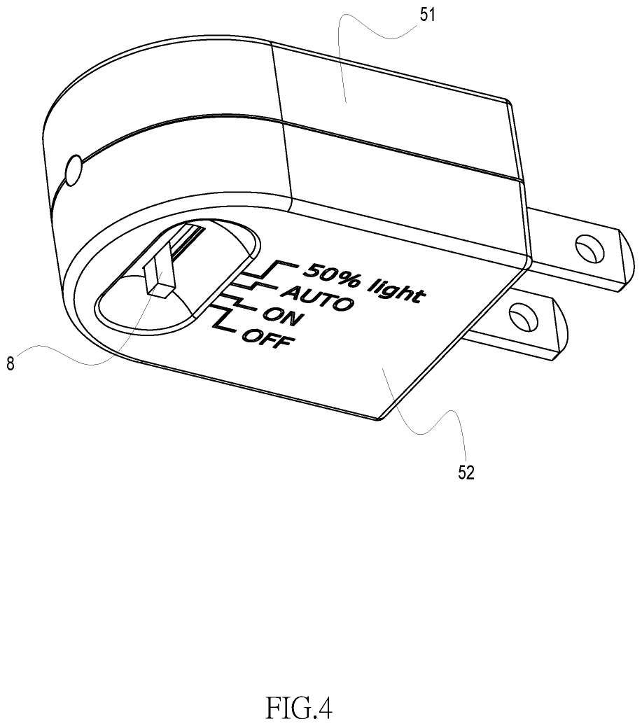

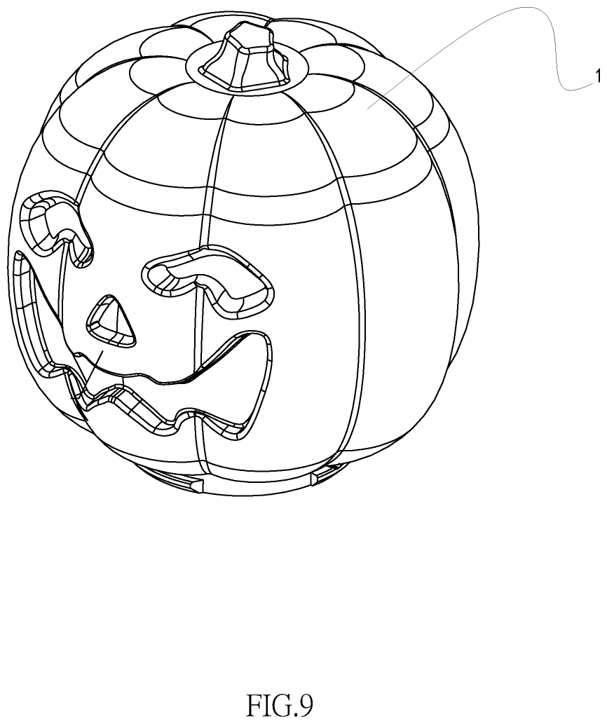

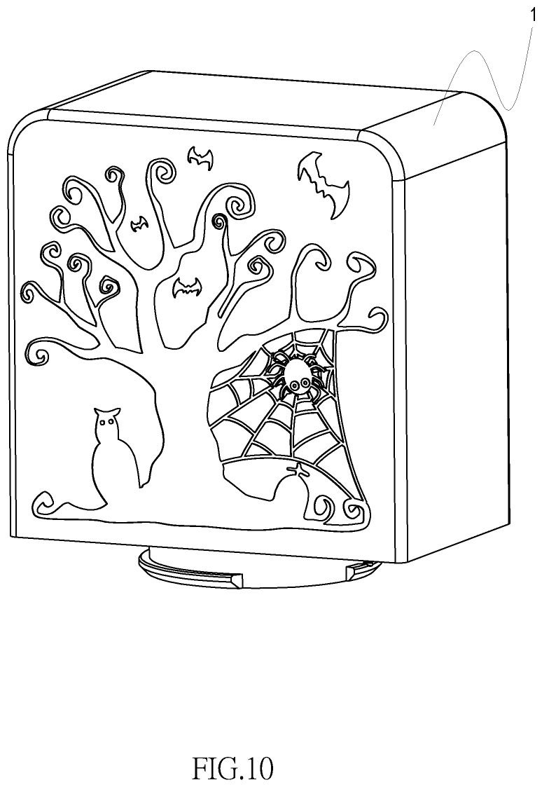

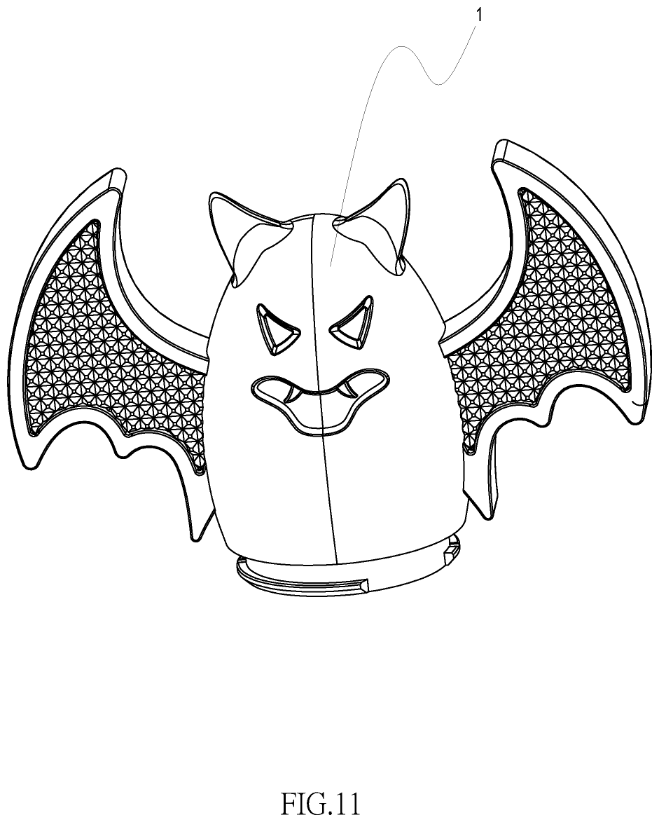

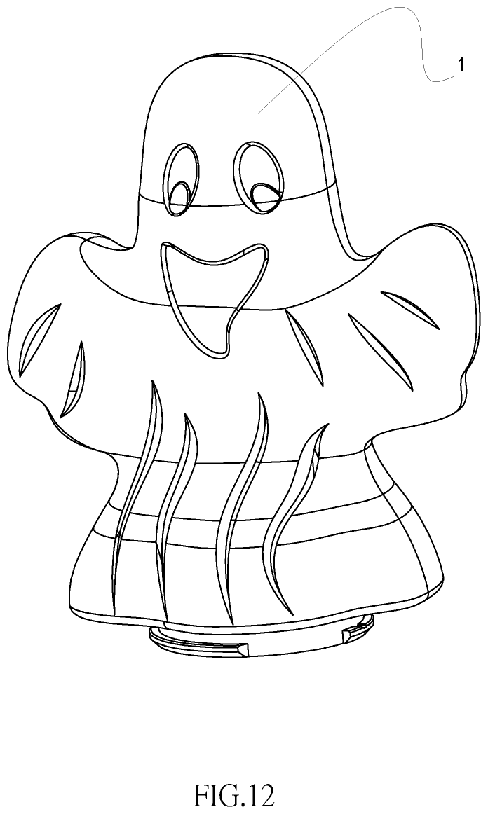

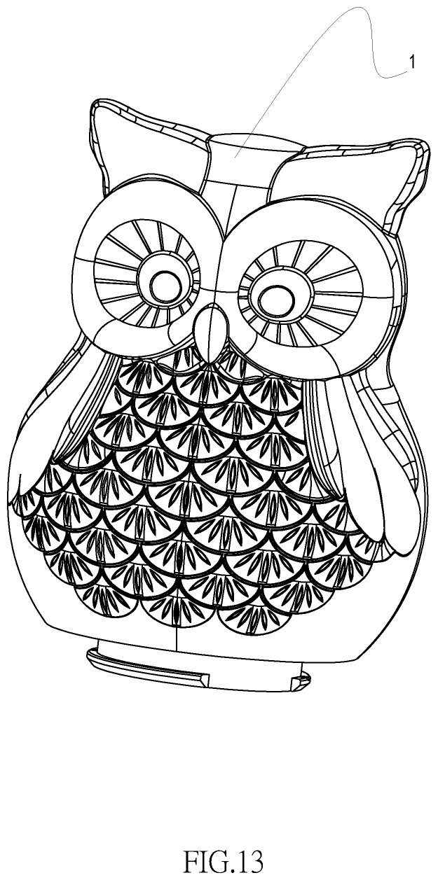

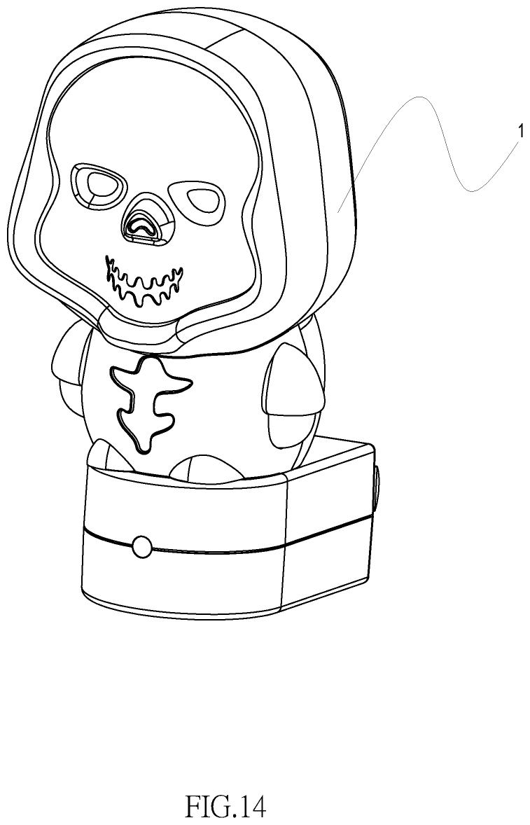

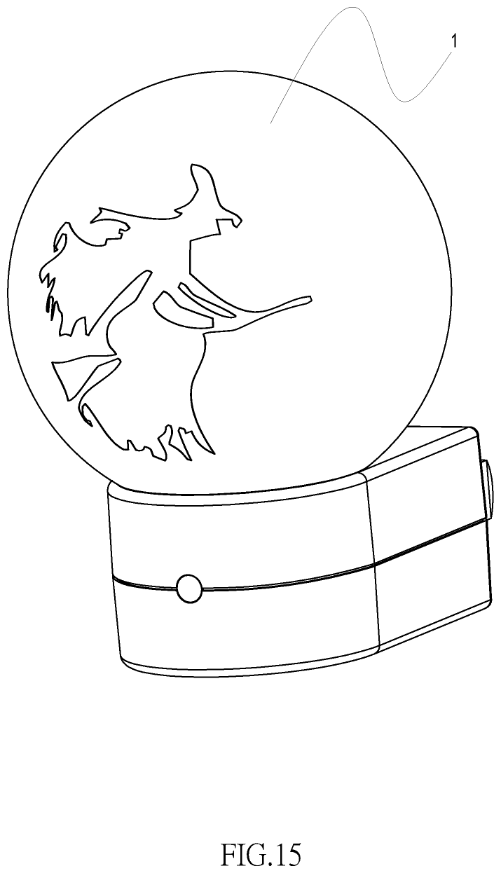

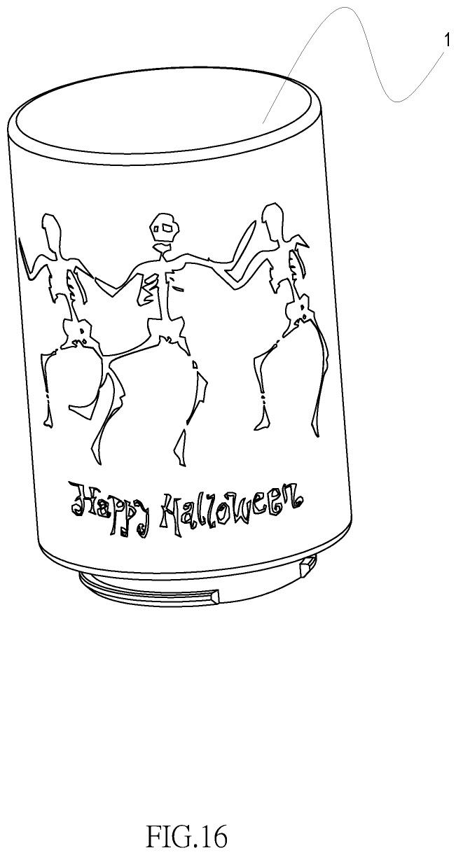

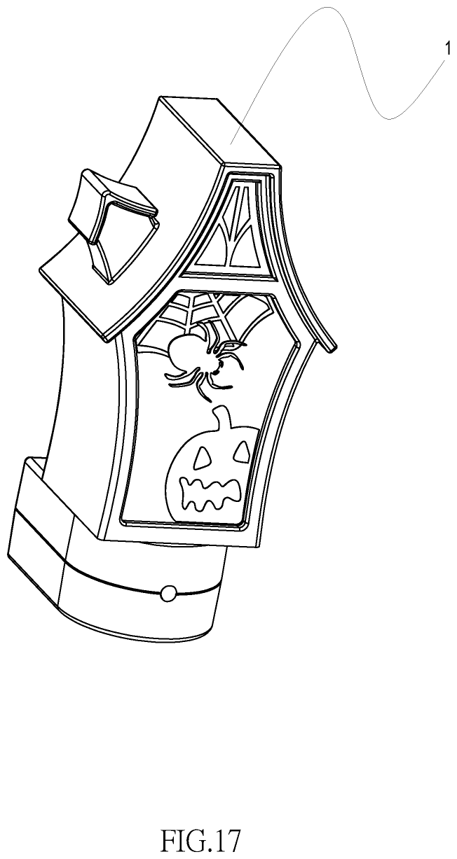

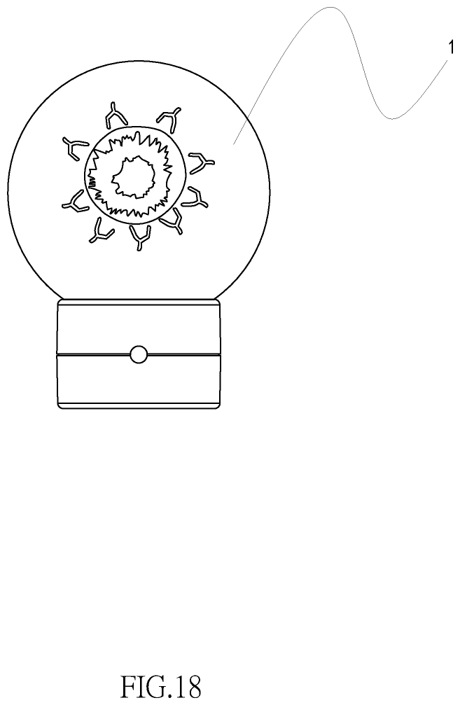

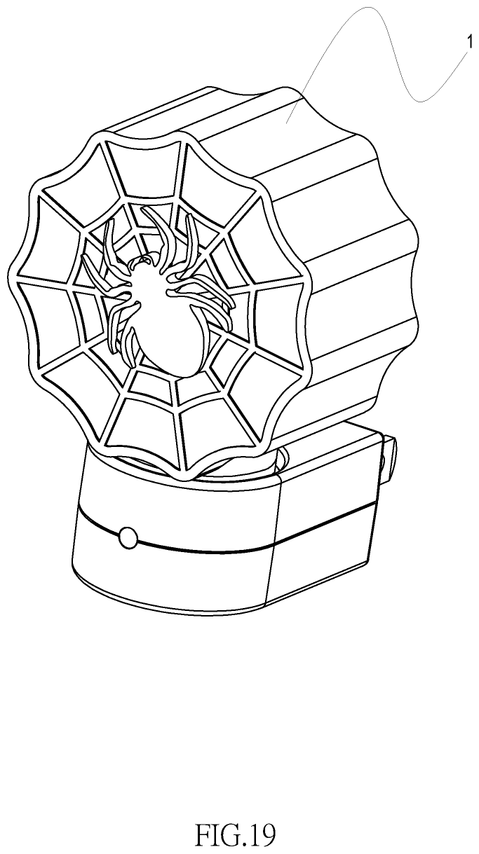

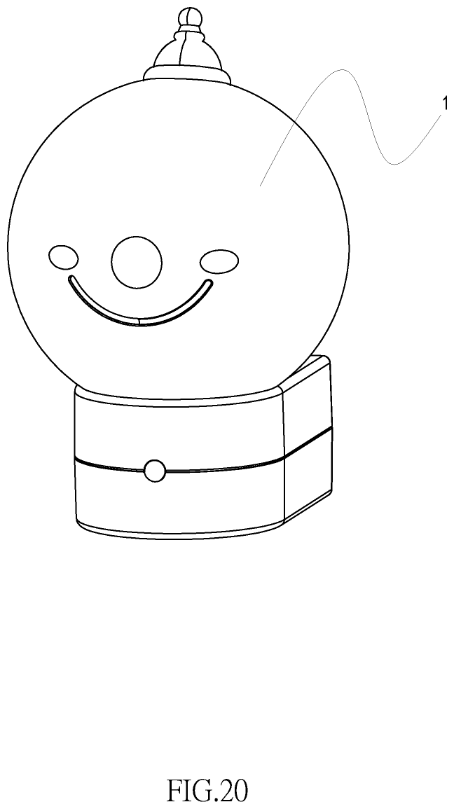

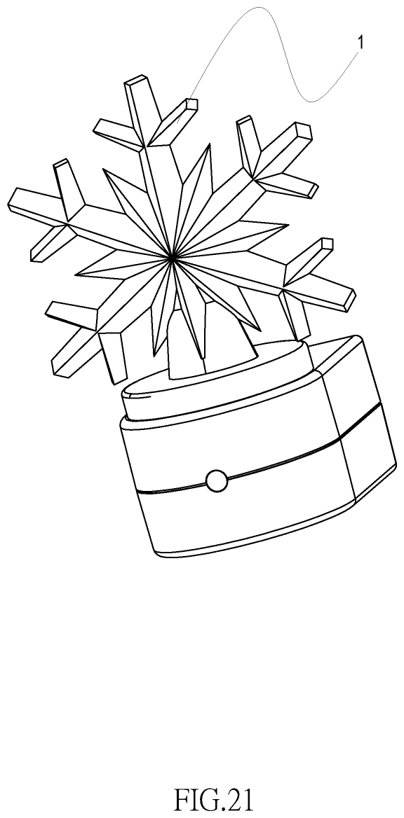

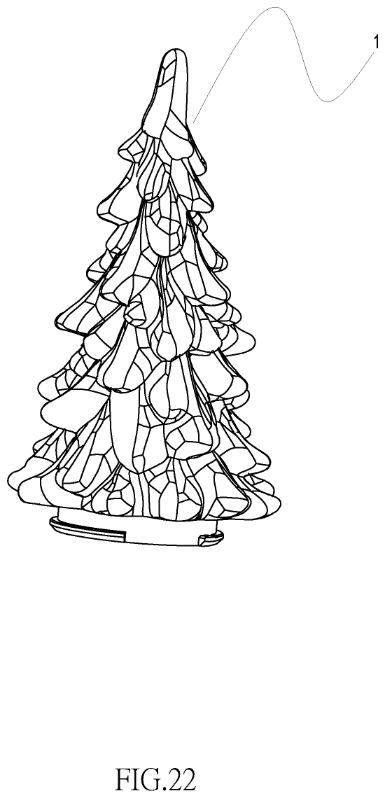

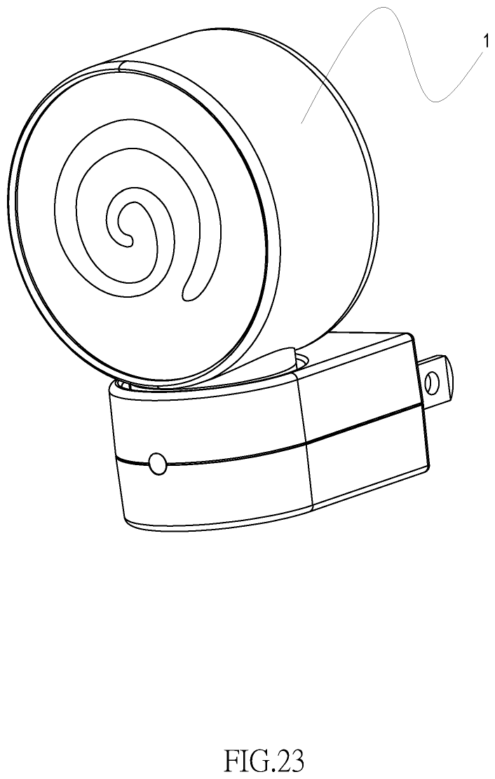

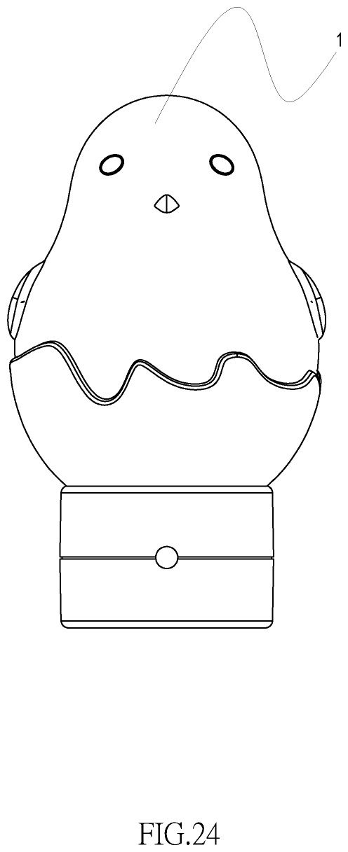

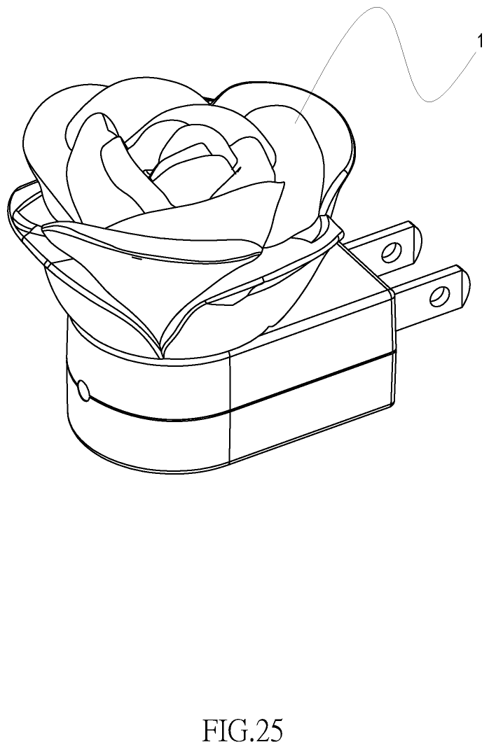

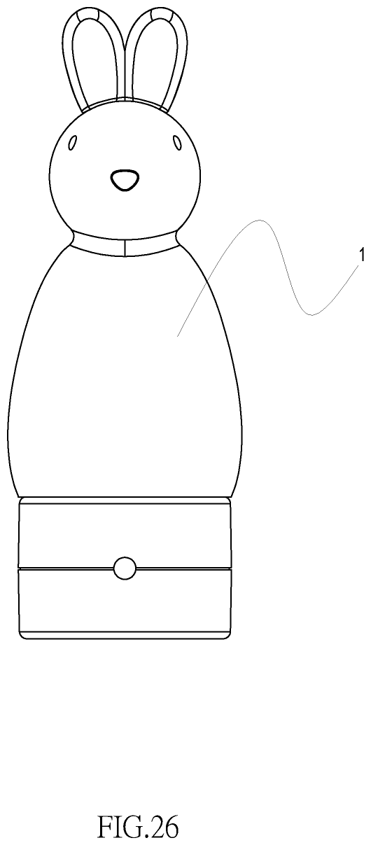

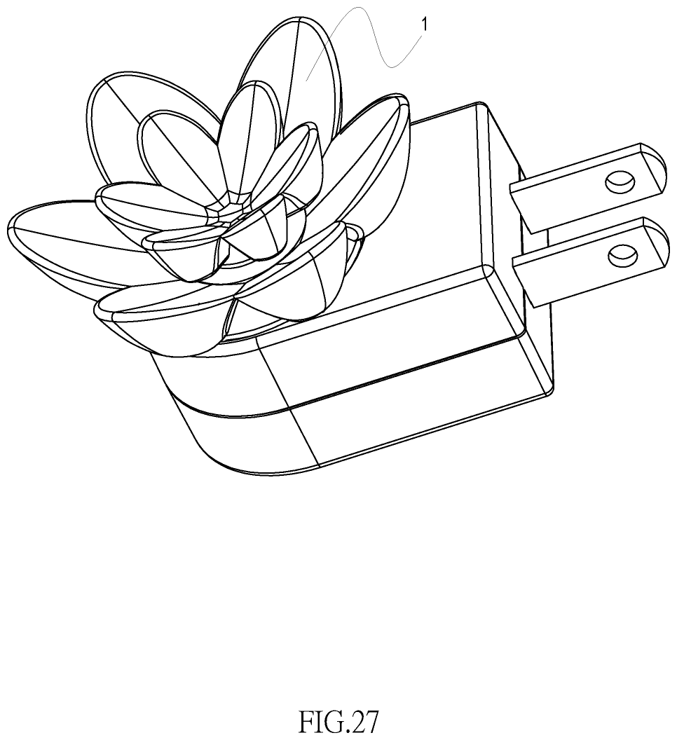

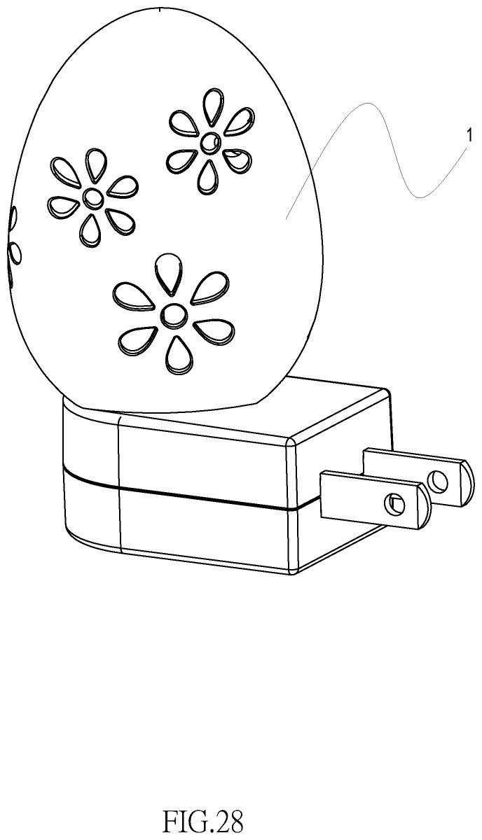

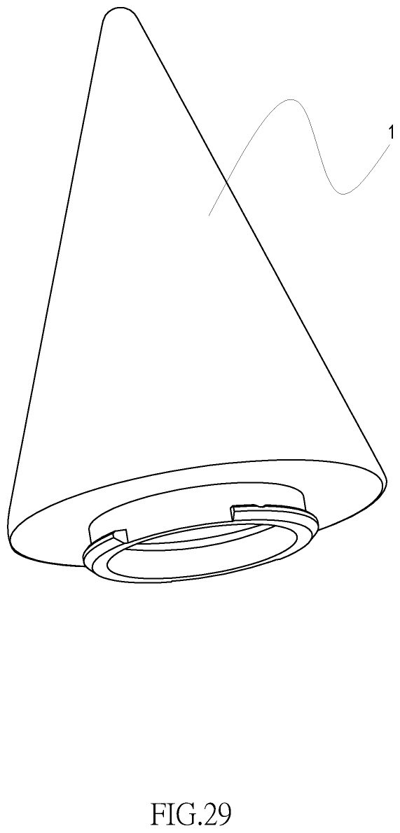

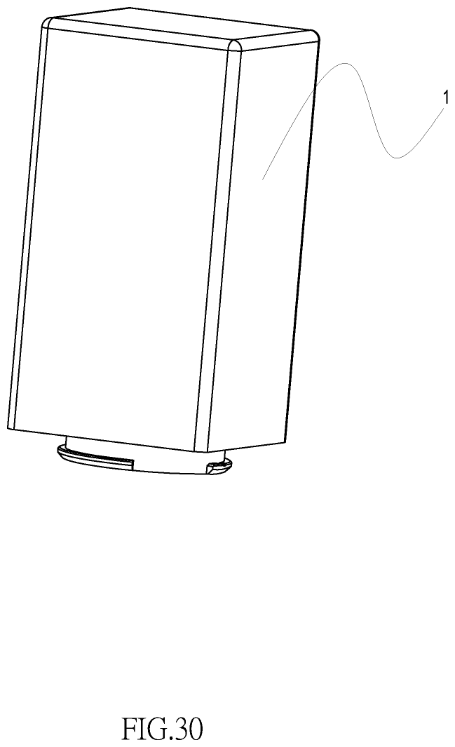

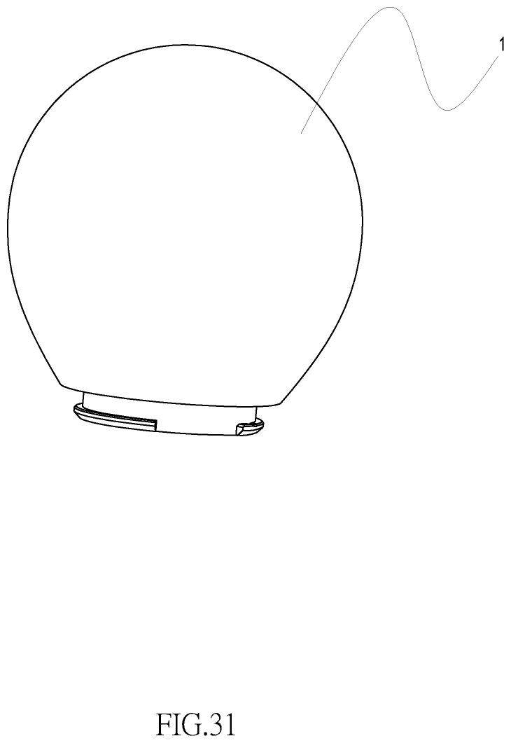

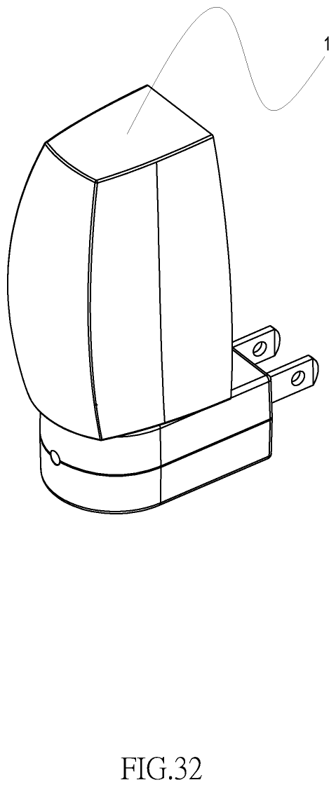

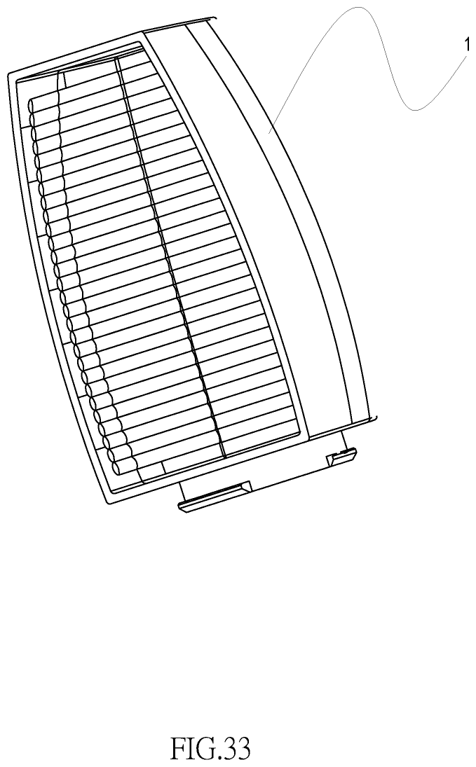

With reference to FIGS. 1 to 33 for a detachable night lamp in accordance with an embodiment of the present invention, the detachable night lamp comprises a lampshade 1, a mounting base 5, and a circuit board 3 installed in the mounting base 5. The circuit board 3 has an illuminator 4 electrically coupled to the circuit board 3. The mounting base 5 has a receiving chamber 21 disposed on the top surface of the mounting base 5. The receiving chamber 21 has a through hole 22 configured to be corresponsive to the illuminator 4. The lampshade 1 has a plug connector 11 disposed at the bottom end of the lampshade 1 for latching and coupling the receiving chamber 21. The plug connector 11 includes a cylinder 112 coupled to the bottom of the lampshade 1 and a semi-circular fastening ring 111 disposed on an outer wall of the cylinder 112. The receiving chamber 21 has a fastening block 23 disposed on an inner wall of the receiving chamber 21 for latching and coupling the semi-circular fastening ring 111.

Specifically, the circuit board 3 supplies power to the illuminator 4, and the light emitted from the illuminator 4 passes through the through hole 22 and the cylinder 112 sequentially and then enters into the lampshade 1 to light up the night lamp. If it is necessary to install the lampshade 1, the lampshade 1 is simply rotated to misalign the semi-circular fastening ring 111 on the outer wall of the cylinder 112 with the fastening block 23 on the inner wall of the receiving chamber 21, so that the whole cylinder 112 at the bottom end of the lampshade 1 falls into the receiving chamber 21. Now, the lampshade 1 is rotated again to tighten up the semi-circular fastening ring 111 with the fastening block 23. If it is necessary to change the lampshade 1 of a different shape, the lampshade 1 is simply rotated to misalign the semi-circular fastening ring 111 with the fastening block 23 in order to remove the lampshade 1. Since the light source is installed on the mounting base 5, every lampshade 1 just needs to have a universal plug connector 11 for different lampshades 1 in order to mount the lampshade 1 onto the mounting base 5. Such arrangement achieves the effects of convenient installation, high practicality, and resources saving. Users may buy one mounting base 5 plus different shaped lampshades 1 to meet the requirement of changing different lampshades 1 for different occasions, so as to save costs.

In an embodiment of a detachable night lamp as shown in FIGS. 1, 5 and 6, the fastening block 23 includes a horizontal portion 231 and a vertical portion 232 coupled to each other to form an inverted L-shape.

Specifically, the vertical portion 232 has the effect of limiting the position to prevent the lampshade 1 from being over-rotated, or misaligning the semi-circular fastening ring 111 with the fastening block 23 again to cause the lampshade 1 falling off

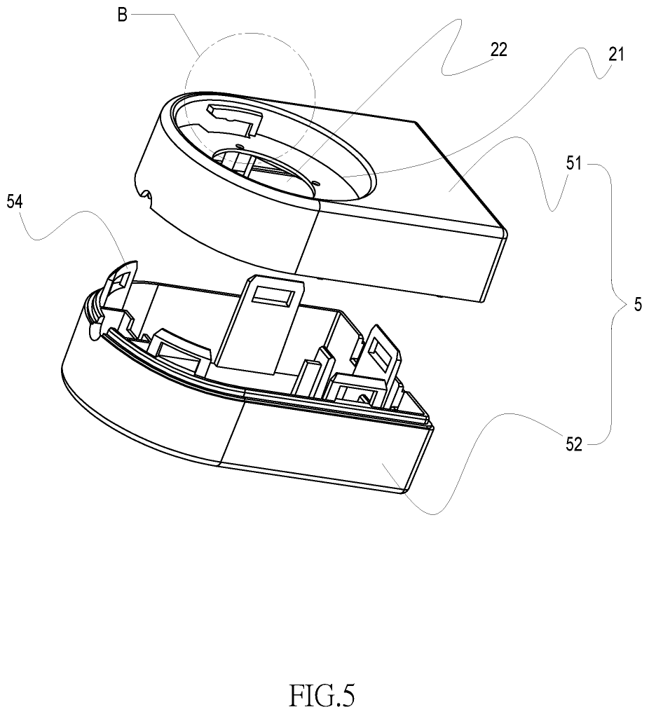

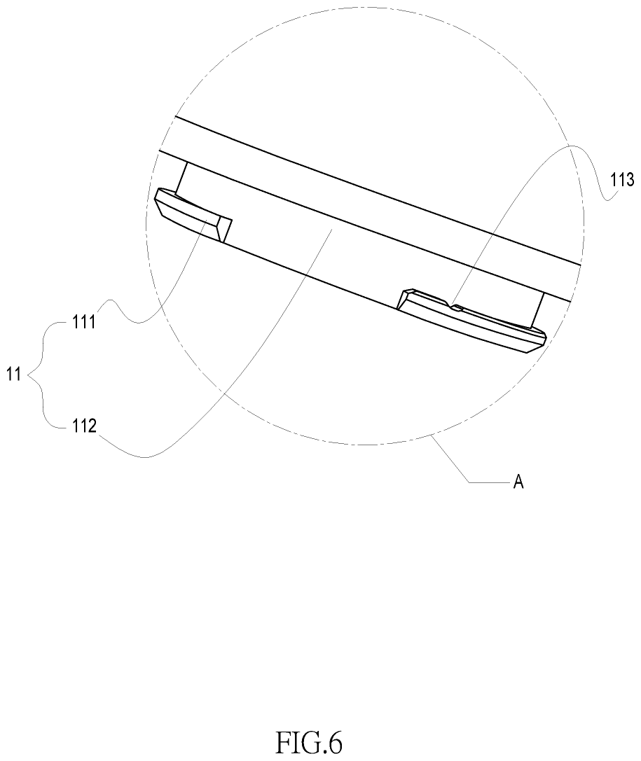

In an embodiment of a detachable night lamp as shown in FIGS. 5 and 6, the semi-circular fastening ring 111 has a notch 113 formed thereon, and the horizontal portion 231 has a bump 233 disposed thereon for latching and coupling the notch 113.

Specifically, the notch 113 and the bump 233 can further strengthen the tightness of the connection between the semi-circular fastening ring 111 and the fastening block 23.

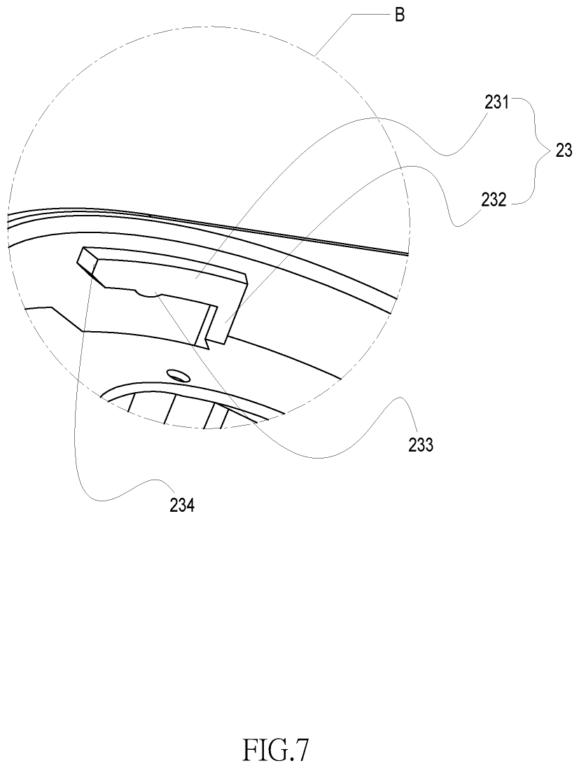

In an embodiment of a detachable night lamp as shown in FIG. 7, the horizontal portion 231 has a guided oblique block 234 disposed at an end of the horizontal portion 231 which is a way from the vertical portion 232.

Specifically, the guided oblique block 234 provides a guiding effect during the process of rotating the lampshade 1 to engage the semi-circular fastening ring 111 and the fastening block 23.

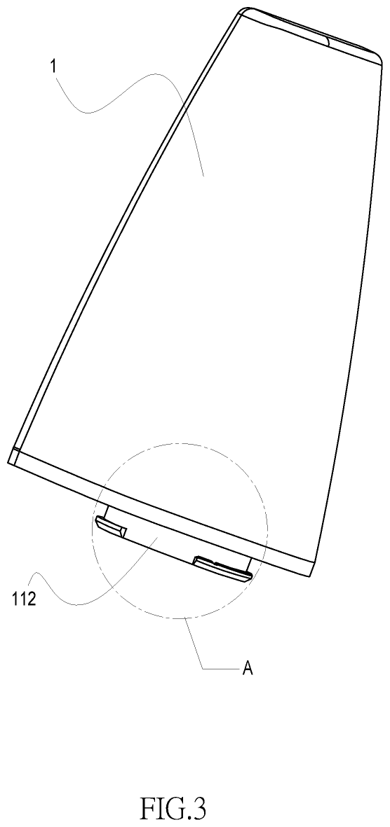

In an embodiment of a detachable night lamp as shown in FIGS. 3 and 6, the semi-circular fastening ring 111 has a chamfer disposed at a bottom edge of the semi-circular fastening ring 111.

Specifically, the semi-circular fastening ring 111 with the chamfer makes it easier to let the cylinder 112 at the bottom end of the lampshade 1 all into the receiving chamber 21.

In an embodiment of a detachable night lamp as shown in FIGS. 5 to 7, the mounting base 5 includes a first base 51 and a second base 52 detachably coupled to each other, and the first base 51 has a latch bump 53, and the second base 52 has a latch groove 54 for latching and coupling the latch bump 53.

Specifically, the latch bump 53 and the latch groove 54 allow the first base 51 and second base 52 to be detachably coupled to each other. Such arrangement makes the repair and maintenance easier when the illuminator 4 breaks down. Since the snap connection is adopted, the installation is very convenient.

In an embodiment of a detachable night lamp as shown in FIGS. 1 to 7, the latch bump 53 is disposed on the inner wall of the first base 51, and the latch groove 54 is formed on the inner wall of the second base 52, and the latch groove 54 has a chamfer disposed at the top of the latch groove 54. Such arrangement facilitates the engagement of the first base 51 with the second base 52.

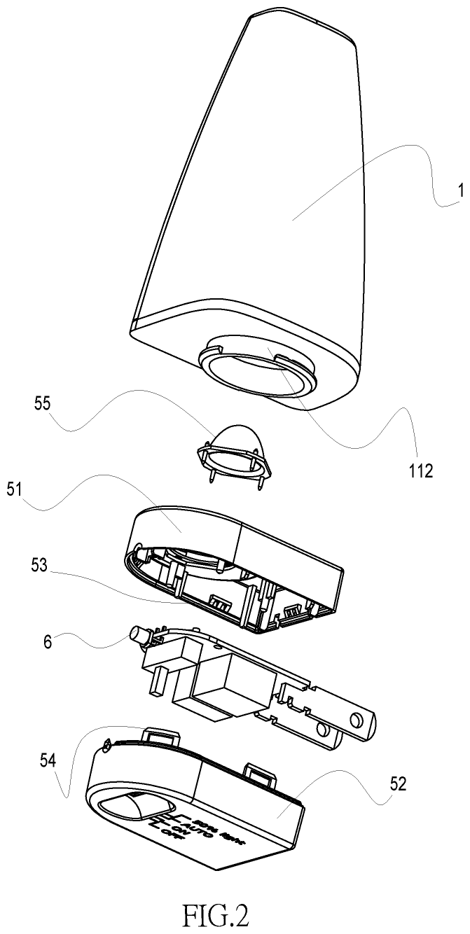

In an embodiment of a detachable night lamp as shown in FIGS. 1 and 2, the detachable night lamp further comprises a diffusion hood 55 mounted onto the through hole 22 for making the light emission more uniformly.

In an embodiment of a detachable night lamp as shown in FIGS. 1 and 2, the detachable night lamp further comprises an induction lamp bead 6, and the mounting base 5 has a via hole formed on a sidewall thereof, and the induction lamp bead 6 is installed in the via hole, and both of the induction lamp bead 6 and the illuminator 4 are electrically coupled to the circuit board 3.

The induction lamp bead 6 may be a photosensitive triode transistor provided for detecting the intensity of the ambient light. If the ambient light is too dark, the circuit board 3 will turn on the illuminator 4 to illuminate the surrounding environment to assure a sufficient brightness. If the ambient light is too bright, the circuit board 3 will turn off the illuminator 4 to save electrical power. With the induction lamp bead 6, the night lamp has a smart sensor function to improve its practicality.

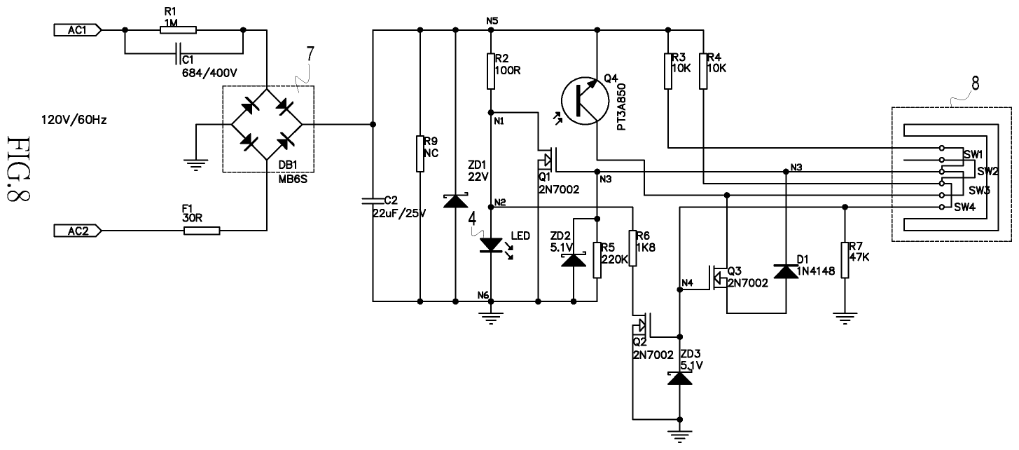

In an embodiment of a detachable night lamp as shown in FIG. 8, the circuit board 3 further comprises a mains electricity interface AC1, a mains electricity interface AC2, a rectifier module 7, a control module and a control switch module 8; the control switch module 8 comprises a disconnect switch SW1, a full-brightness switch SW2, an automatic-brightness switch SW3 and a half-brightness switch SW4; both of the mains electricity interface AC1 and the mains electricity interface AC2 are coupled to the control module through the rectifier module 7; the control module comprises a positive input node N5 coupled to a positive output terminal of the rectifier module 7 and a negative input node N6 coupled to a negative output terminal of the rectifier module; the control module further comprises a field effect transistor Q1, a field effect transistor Q2, a field effect transistor Q3, a photosensitive triode transistor Q4, a pull-up resistor R2, a pull-up resistor R3, a pull-up resistor R4 and a pull-up resistor R5; a pull-up resistor R2 and an illuminator 4 are coupled to each other and installed sequentially between the positive input node N5 and the negative input node N6; the disconnect switch SW1 has an end coupled to the positive input node N5 through the pull-up resistor R3; the half-brightness switch SW4 has an end coupled to the positive input node N5 through the pull-up resistor R4; the full-brightness switch SW2 has an end coupled to the positive input node N5 through the pull-up resistor R4; and the other end of the full-brightness switch SW2 is suspended in the air; a node N1 and a node N2 are disposed between the pull-up resistor R2 and the illuminator 4; the other end of the disconnect switch SW1 is coupled to the gate of the field effect transistor Q1; a drain of the field effect transistor Q1 is coupled to the node N1; a source of the field effect transistor Q1 is coupled to the negative input node N6; the automatic-brightness switch SW3 has an end coupled to a collector of the photosensitive triode transistor Q4 and the other end coupled to a gate of the field effect transistor Q1; an emitter of the photosensitive triode transistor Q4 is coupled to the positive input node N5; a node N3 is disposed between the other end of the automatic-brightness switch SW3 and the gate of the field effect transistor Q1; the other end of the half-brightness switch SW4 is coupled to the gate of the field effect transistor Q2; the source of the field effect transistor Q2 is coupled to the negative input node N6; the drain of the field effect transistor Q2 is coupled to the node N2; a node N4 is disposed between the other end of the half-brightness switch SW4 and the gate of the field effect transistor Q2; the gate of the field effect transistor Q3 is coupled to the node N4; the drain of the field effect transistor Q3 is coupled to the collector of the photosensitive triode transistor Q4; the source of the field effect transistor Q3 is coupled to the gate of the field effect transistor Q1 through the source and the node N3; the source of field effect transistor Q3 is coupled to the negative input node N6 through the node N3 and the pull-up resistor R5 sequentially; a resistor R6 is installed between the drain of the field effect transistor Q2 and the node N2; and the node N4 is coupled to the negative input node N6 through the resistor R7.

During use, if any one switch of the control switch module 8 is turned off and all other switches are disconnected, the field effect transistor Q1 will control the ON/OFF of the illuminator 4.

If the disconnect switch SW1 is turned off, the field effect transistor Q1 will be electrically conducted, but both pf the field effect transistor Q2 and the field effect transistor Q3 will not be electrically conducted. Since the resistance at the field effect transistor Q1 is very small, therefore both terminals of the illuminator 4 will be shorted circuit, and the illuminator 4 will be turned off.

If the full-brightness switch SW2 is turned off, the field effect transistor Q1, the field effect transistor Q2, and the field effect transistor Q3 will not be electrically conducted, and the illuminator 4 will be turned on.

If the automatic-brightness switch SW3 is turned off, the photosensitive triode transistor Q4 is installed and connected to the circuit, and the light intensity reaches a specific value, then the photosensitive triode transistor Q4 will be electrically conducted, so that the gate voltage of the field effect transistor Q1 is higher than a threshold voltage, and the field effect transistor Q1 will be electrically conducted, so s to turn off the illuminator 4. If the light intensity is lower than a specific value, then the photosensitive triode transistor Q4 will not be electrically conducted, and the photosensitive triode transistor Q4 is sutured at an open-circuit state, and the gate of the effect transistor Q1 is very small. Therefore, the illuminator 4 will be turned on normally.

If the half-brightness switch SW4 is turned off and both gate voltages of the field effect transistor Q2 and the field effect transistor Q3 is higher than the threshold voltage, then the field effect transistor Q2 will be electrically conducted. When the resistor R5 is installed and connected to the circuit, the voltage at both terminals of the illuminator 4 is reduced, and the power of the illuminator 4 is halved to weaken the brightness. Since the photosensitive triode transistor Q4 is installed and connected to the circuit, therefore when the light intensity reaches a specific value, the photosensitive triode transistor Q4 will be electrically conducted, and the drain voltage of the field effect transistor Q3 will be higher than the source voltage of the field effect transistor Q3, and the gate voltage of the field effect transistor Q1 is higher than the threshold voltage, so as to turn off the illuminator 4. On the other hand, if the light intensity is lower than a specific value, then the photosensitive triode transistor Q4 will be at the open-circuit state, and the field effect transistor Q3 will not be electrically conducted, and the illuminator 4 will be turned on normally.

While the present invention has been described by means of specific embodiments, numerous modifications and variations could be made thereto by those skilled in the art without departing from the scope and spirit of the present invention set forth in the claims.

What is claimed is:

1. A detachable night lamp, comprising: a lampshade, a mounting base, a circuit board disposed in the mounting base; an illuminator installed onto the circuit board and electrically coupled to the circuit board, and a receiving chamber formed at the top surface of the mounting base and having a through hole formed at a position corresponding to the illuminator;
the lampshade having a plug connector disposed at the bottom end thereof and provided for latching and coupling the receiving chamber;
the plug connector including a cylinder coupled to the bottom of the lampshade and a semi-circular fastening ring disposed on an outer wall of the cylinder;
the receiving chamber having a fastening block disposed on an inner wall thereof and provided for latching and coupling the semi-circular fastening ring.

2. The detachable night lamp of claim 1, wherein the fastening block includes a horizontal portion and a vertical portion coupled to each other to form an inverted L-shape.

3. The detachable night lamp of claim 2, wherein the semi-circular fastening ring has a notch formed thereon, and the horizontal portion has a bump provided for latching and coupling with the notch.

4. The detachable night lamp of claim 2, wherein the horizontal portion has a guided oblique block disposed at an end of the horizontal portion which is away from the vertical portion.

5. The detachable night lamp of claim 1, wherein the semi-circular fastening ring has a chamfer disposed at a bottom edge thereof.

6. The detachable night lamp of claim 1, wherein the mounting base includes a first base and a second base, and the first base and the second base are detachably coupled, and the first base has a latch bump, and the second base has a latch groove for latching and coupling the latch bump.

7. The detachable night lamp of claim 6, wherein the latch bump is disposed on an inner wall of the first base, and the latch groove is formed on an inner wall of the second base, and the latch groove has a chamfer disposed at the top thereof.

8. The detachable night lamp of claim 1, further comprising a diffusion hood mounted onto the through hole.

9. The detachable night lamp of claim 1, further comprising an induction lamp bead, and the mounting base having a via hole formed on a sidewall thereof, and the induction lamp bead being installed in the via hole, and both of the induction lamp bead and the illuminator being electrically coupled to the circuit board.

10. The detachable night lamp of claim 1, wherein the circuit board further comprises a first mains electricity interface, a second mains electricity interface, a rectifier module, a control module and control switch module; the control switch module comprises a disconnect switch, a full-brightness switch, an automatic-brightness switch and a half-brightness switch; both the first mains electricity interface and the second mains electricity interface are coupled to the control module through the rectifier module; the control module comprises a positive input node coupled to a positive output terminal of the rectifier module and a negative output terminal coupled to a negative input node of the rectifier module; the control module further comprises a first field effect transistor, a second field effect transistor, a third field effect transistor, a photosensitive triode transistor, a first pull-up resistor, a second pull-up resistor, a third pull-up resistor and a fourth pull-up resistor; the second pull-up resistor and an illuminator are coupled to each other and installed sequentially between the positive input node and the negative input node; the disconnect switch has an end coupled to the positive input node through the second pull-up resistor; the half-brightness switch has an end coupled to the positive input node through the third pull-up resistor; the full-brightness switch has an end coupled to the positive input node through the third pull-up resistor and the other end suspended in the air; a first node and a second node are disposed between the first pull-up resistor and the illuminator; the other end of the disconnect switch is coupled to a gate of the first field effect transistor; a drain of the first field effect transistor is coupled to the first node; a source of the first field effect transistor is coupled to the negative input node; the automatic-brightness switch has an end coupled to a collector of the photosensitive triode transistor and the other end coupled to the gate of the first field effect transistor; an emitter of the photosensitive triode transistor is coupled to the positive input node; a third node is disposed between the other end of the automatic-brightness switch and the gate of the first field effect transistor; the other end of the half-brightness switch is coupled to a gate of the second field effect transistor; a source of the second field effect transistor is coupled to the negative input node; a drain of the second field effect transistor is coupled to the second node; a fourth node is disposed between the other end of the half-brightness switch and the gate of the second field effect transistor; a gate of the third field effect transistor is coupled to the fourth node; a drain of the third field effect transistor is coupled to a collector of the photosensitive triode transistor; a source of the third field effect transistor is coupled to the gate of the first field effect transistor through the third node; a source of the third field effect transistor is coupled to the negative input node through the third node and the fourth pull-up resistor; a first resistor is installed between the drain of the second field effect transistor and the second node; and the fourth node is coupled to the negative input node through a second resistor.
